(19) United States
(12) Patent Application Publication
(10) Pub. No.: US 2012/0109832 A1
(43) Pub. Date: May 3, 2012

(54) Rate Evaluation and Planning

(75) Inventor: Faith Terry Hemenway, Fort Mill, SC (US)

(73) Assignee: Bank of America Corporation, Charlotte, NC (US)

(21) Appl. No.: 12/938,239

(22) Filed: Nov. 2, 2010

(51) Int. Cl. G06Q 10/00

(52) U.S. Cl. 705/307

(57) ABSTRACT

According to one embodiment of the present invention, a method receives a request for charge information associated with a selected leased space of a plurality of leased spaces. The method accesses lease data and determines an area measurement and a rate associated with the selected leased space. The method calculates a charge amount based on the area measurement and the rate and determines charge information associated with the charge amount.

### TECHNICAL FIELD OF THE INVENTION

The present invention relates generally to leases and more specifically to providing rate evaluation and planning.

### BACKGROUND OF THE INVENTION

A lease provides terms according to which a party rents a leased space. Certain parties, such as large enterprises, may manage portfolios of many leases. A particular leased space may be utilized by an occupant associated with the enterprise, such as a line of business or a department of the enterprise, and different leased spaces may be utilized by different occupants. To recoup lease expenses, the enterprise may allocate charges among cost centers responsible for the occupants utilizing the leased spaces.

### SUMMARY OF THE INVENTION

In accordance with the present invention, disadvantages and problems associated with rate evaluation and planning may be reduced or eliminated.

According to one embodiment of the present invention, a method receives a request for charge information associated with a selected leased space of a plurality of leased spaces. The method accesses lease data and determines an area measurement and a rate associated with the selected leased space. The method calculates a charge amount based on the area measurement and the rate and determines charge information associated with the charge amount.

Certain embodiments of the invention may provide one or more technical advantages. A technical advantage of one embodiment includes assimilating data for a number of leases. Another technical advantage includes mapping leased spaces to call centers responsible for paying lease charges. Yet another technical advantage includes determining whether a potential lease rate does not result in the complete recovery of forecasted lease expenses. The foregoing advantages may allow for increased efficiency during rate evaluation and planning. Another technical advantage of an embodiment includes performing audits to identify changed data.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system that assimilates data to facilitate rate evaluation and planning;

FIG. 2 illustrates an example of a report used for rate evaluation and planning; and

FIG. 3 illustrates a flowchart for rate evaluation and planning.

### DETAILED DESCRIPTION OF THE INVENTION

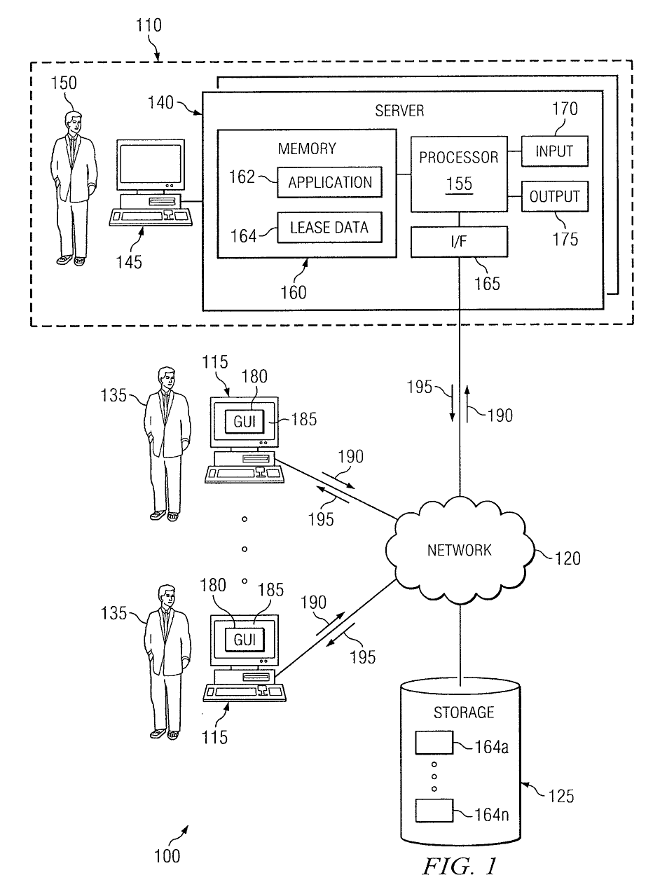

Embodiments of the present invention and its advantages are best understood by referring to FIGS. 1 through 3 of the drawings, like numerals being used for like and corresponding parts of the various drawings.

A lease provides terms according to which a party rents a leased space. Certain parties, such as large enterprises, may manage portfolios of many leases. A particular leased space may be utilized by an occupant associated with the enterprise, such as a line of business or a department of the enterprise, and different leased spaces may be utilized by different occupants. To recoup lease expenses, the enterprise may allocate charges among cost centers responsible for the occupants utilizing the leased spaces. Managing a large number of leases increases the complexity and inefficiency of allocating charges among cost centers and planning lease rates. FIGS. 1 through 3 below illustrate a system and method for rate evaluation and planning that may be used to efficiently manage a number of leases.

FIG. 1 illustrates a system 100 according to certain embodiments. System 100 may include an enterprise 110, one or more clients 115, a network storage device 125, one or more servers 140, and one or more users 135. Enterprise 110, clients 115, and network storage device 125 may be communicatively coupled by a network 120. Enterprise 110 is generally operable to provide report 195, as described below.

In general, one or more servers 140 may provide report 195 to users 135. User 135 provides a request 190 to server 140 via client 115 requesting charge information. In response, server 140 accesses lease data 164 associated with request 190 and determines the charge information. Server 140 then communicates report 195 to user 135 via client 115, report 195 indicates the charge information.

Client 115 may refer to any device that enables user 135 to interact with server 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface such as a display 185, microphone, keyboard, or any other appropriate terminal equipment usable by user 135. It will be understood that system 100 may comprise any number and combination of clients 115. User 135 utilizes client 115 to interact with server 140 to receive report 195, as described below. In some embodiments, user 135 may be a person that evaluates lease performance and plans future leases, such as an employee of a financial institution or other enterprise that manages leased spaces.

In some embodiments, client 115 may include a graphical user interface (GUI) 180. GUI 180 is generally operable to tailor and filter data entered by and presented to user 135. GUI 180 may provide user 135 with an efficient and user-friendly presentation of request 190 and/or report 195. GUI 180 may comprise a plurality of displays having interactive fields, pull-down lists, and buttons operated by user 135. GUI 180 may include multiple levels of abstraction including groupings and boundaries. It should be understood that the term GUI 180 may be used in the singular or in the plural to describe one or more GUIs 180 and each of the displays of a particular GUI 180.

In some embodiments, network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Network storage device 125 may store any data and/or instructions utilized by server 140.

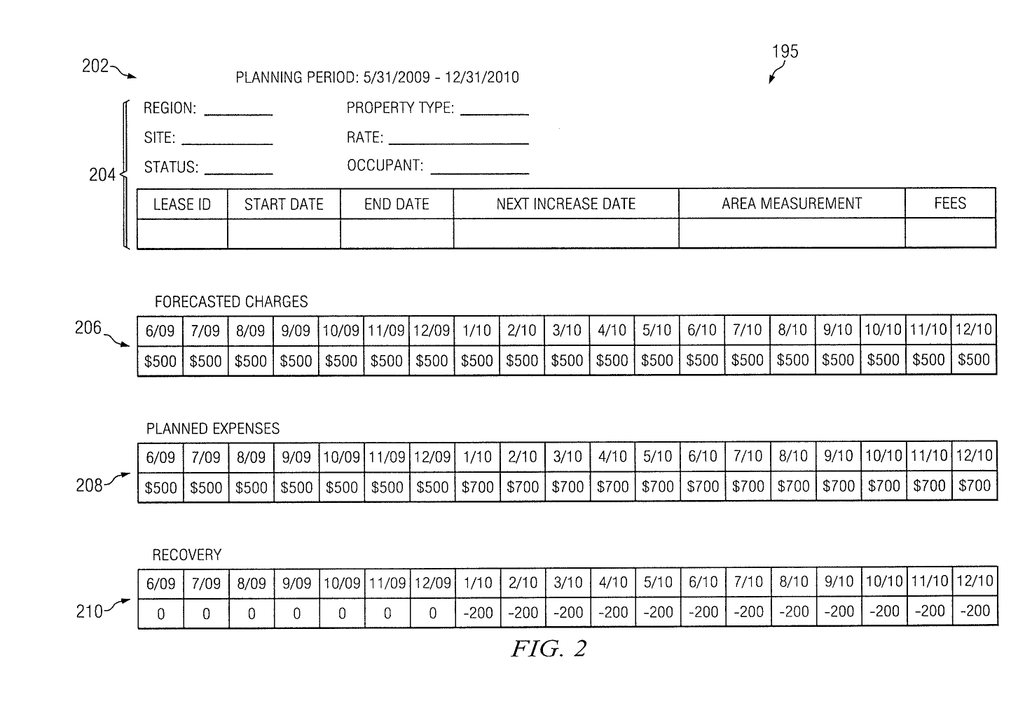

In the illustrated embodiment, network storage device 125 stores lease data 164a to 164n describing a plurality of leases. Lease data 164 may include any data suitable for describing a lease. As an example, lease data 164 may include an area measurement and a rate. The area measurement describes the size of the leased space, for example, the number of square feet, square meters, rooms, floors, or any other measurement. The rate describes charges per unit of area measurement, such as dollars per square foot. As another example, lease data 164 may include expense data, such as base expenses and/or operating expenses. Expense data may refer to actual expense data for an elapsed time period or forecasted expense data for a future time period. Accordingly, expense data may be represented on a periodic basis, such as monthly, quarterly, semi-annually, or annually. Other examples of lease data include information used to characterize the lease, such as region, site, property type, status, lease identifier, lease term, lease start date, lease end date, next increase date, applicable fees, contact names, rent methodology, a master lease identifier indicating related leases, comments, occupant information (e.g., name, line of business, and/or department), and so on. Lease characteristics are described in more detail with respect to FIG. 2.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 140, an administrator workstation 145, and an administrator 150. In some embodiments, server 140 may refer to any suitable combination of hardware and/or software implemented in one or more modules to process data and provide the described functions and operations. In some embodiments, the functions and operations described herein may be performed by a pool of servers 140. In some embodiments, server 140 may include, for example, a mainframe, server, host computer, workstation, web server, file server, a personal computer such as a laptop, or any other suitable device operable to process data. In some embodiments, server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 140 receives lease data 164, determines charge information, and provides report 195 to users 135. In some embodiments, server 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 140, it should be understood that server memory 160 may be internal or external to server 140, depending on particular implementations. Also, server memory 160 may be separate from or integral to other memory devices to achieve any suitable arrangement of memory devices for use in system 100.

Server memory 160 is generally operable to store an application 162 and lease data 164. Application 162 generally refers to logic, rules, algorithms, code, tables, and/or other suitable instructions for performing the described functions and operations. Application 162 may access rules from server memory 160 and may indicate actions to perform to certain lease data. Rules may be determined from request 190, pre-configured, or both. Pre-configured rules may be defined for an enterprise, an entity, a line of business, an individual user, and so on. As an example, rules may be defined to map a leased space identified by lease data 164 to an occupant and/or a cost center for the lease. As another example, rules may be defined to compare planned lease expenses to planned charges and determine whether or not the changes fully recover the lease expenses. In some embodiments, application 162 facilitates preparing report 195 and communicating report 195 to users 135.

Server memory 160 communicatively couples to processor 155. Processor 155 is generally operable to execute application 162 stored in server memory 160 to provide report 195 according to the disclosure. Processor 155 may comprise any suitable combination of hardware and software implemented in one or more modules to execute instructions and manipulate data to perform the described functions for servers 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 140, send output from server 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 120 or other communication system that allows server 140 to communicate to other devices. Communication interface 165 may include any suitable software operable to access data from various devices such as clients 115 and/or network storage device 125. Communication interface 165 may also include any suitable software operable to transmit data to various devices such as clients 115 and/or network storage device 125. Communication interface 165 may include one or more ports, conversion software, or both. In general, communication interface 165 receives request 190 from clients 115 and transmits report 195 to clients 115.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 140 using an administrator workstation 145. In some embodiments, administrator workstation 145 may be communicatively coupled to server 140 and may refer to any suitable computing system, workstation, personal computer such as a laptop, or any other device operable to process data. In certain embodiments, an administrator 150 may utilize administrator workstation 145 to manage server 140 and any of the data stored in server memory 160 and/or network storage device 125. In some embodiments, administrator 150 may authorize users 135 to interact with lease data 164 according to one or more access levels. For example, certain users 135 may be authorized to interact with lease data 164 according to a read-only access level. Read-only access allows user 135 to request and view reports 195, but does not allow the user to modify any lease data 164. Other users 135 may be granted increased authorization rights that allow for setting up rules and/or adding, modifying, or deleting lease data 164.

In an exemplary embodiment of operation, application 162, upon execution by processor 155, facilitates assimilating lease data 164 and communicates report 195 to users 135. Application 162 may facilitate assimilating lease data 164 in response to request 190. In some embodiments, user 135 submits request 190 on client 115 to request report 195. Request 190 may request charge information associated with lease data 164 for a particular leased space or for one or more categories of lease data 164. As an example, request 190 may request lease data 164 for leases categorized as having an active status. Request 190 may optionally include a planning period indicating the dates that user 135 requests to evaluate. Request 190 may optionally describe the type of information user 135 requests to evaluate. For example, the user may request current charges and/or cost center responsible for the charges, or the user may request forecasted charges and/or certain planning information. In response to user 135 requesting report 195, application 162 may request lease data 164 from network storage device 125.

In some embodiments, application 162 determines rules to be applied to lease data 164. Application 162 may determine the rules to apply according to the request and/or according to pre-configured criteria. An example of a rule based on the request may be to select a category of lease data 164 indicated by the request and to perform an action according to the category. A category may refer to leases sharing a common characteristic, such as lease characteristics 204 described with respect to FIG. 2. For example, user 135 may request to filter data to show only lease data 164 associated with the Western region. User 135 may further request to apply a rate change to the lease data associated with the category, such as a 5% increase to the rates for lease data 164 associated with the Western region.

As another example, a rule may map a leased space indicated by the lease data to an occupant and/or a cost center for the lease. As yet another example, a rule may compare planned lease expenses to planned charges and determine whether the planned charges cover the planned lease expenses. Application 162 applies the rules to lease data 164 to determine the information to include in report 195 and sends report 195 to user 135 to communicate the requested data. FIG. 2 provides an example of report 195.

In some embodiments, user 135 may request application 162 to apply modifications to lease data 164. For example, user 135 may request modifications in the event the expenses are more than the charges. An example of a modification may be to increase the rate (e.g., dollars per square foot) for the leased space. Upon receiving a request for a modification, application 162 applies the modification and updates the charge information in report 195 accordingly. Application 162 communicates updated report 195 to user 135 so that user 135 may evaluate the effect of the modification. If the result of the modification is satisfactory, user 135 may recommend to implement the modification.

FIG. 2 illustrates an example of report 195 used for rate evaluation and planning. Report 195 may be generated by application 162 using lease data 164. In the example, report 195 describes a single lease, however, other reports 195 may aggregate data from multiple leases to provide planning information for a category of leases. For example, a site (e.g., a building), may include a number of leased spaces (e.g., floors or offices) for which rates may be planned separately (e.g., floor-by-floor or office-by-office), or together according to the site category. To plan categories of leased spaces together, the same potential rate may be selected for all of the leased spaces in the category, or a uniform modification, such as a 5% increase to the various current rates, may be selected in order to maintain multiple rates within the category.

Report 195 may include a planning period 202, lease characteristics 204, forecasted charges 206, expense data 208, and planning data 210. Planning period 202 may refer to the period being evaluated by the user for planning purposes. In the example, the planning period runs from May 31, 2009 to Dec. 31, 2010.

Lease characteristics 204 include information used to characterize the lease, such as region, site, status, property type, or rate. Region refers to the geographical area where the leased property is located, such as the Northeast, Mid-Atlantic, South, Central, or West. Site refers to the particular leased property, such as an address of a building. Property type describes the type of property, for example, whether the property is an office space, an automatic teller machine (ATM), commercial property, residential property, multi-tenant property, or any other type of property. Status refers to whether the lease is new, active, expired, renewed, or other applicable status. Rate describes charges per a unit of area measurement, such as dollars per square foot. Other examples of lease characteristics 204 include lease identifier, lease term, lease start date, lease end date, area measurement of the leased space (e.g., number of square feet, square meters, floors, rooms, and so on), date of next rate increase, applicable fees, contact names, rent methodology, a master lease identifier indicating related leases, occupant (e.g., name, line of business, and/or department), comments, and so on.

Forecasted charges 206 refer to a charge amount determined from the area measurement and the rate. For forecasting purposes, the area measurement may refer to a planned area measurement and the rate may refer to a potential rate proposed by the user for evaluation purposes. The planned area measurement may be determined based on the planning period and the corresponding lease status. For example, if a new lease will include adding another floor to the leased space during the planning period, the planned area measurement will include the additional floor. Forecasted charges 206 may be represented on a periodic basis, such as monthly, quarterly, semi-annually, or annually. The example illustrates a report prepared prior to May 31, 2009 that forecasts charges for the May 31, 2009 to Dec. 31, 2010 planning period.

Expense data 208 describes base expenses and/or operating expenses associated with the leased space. Expense data 208 may be represented on a periodic basis, such as monthly, quarterly, semi-annually, or annually, and may include actual expenses for an elapsed time period and/or planned (i.e., forecasted) expenses for a future time period. Actual expenses may be derived from data associated with active leases and recently expired leases (i.e., leases that were active during the relevant elapsed time period). Planned expenses may be derived from data associated with active leases, new leases, and/or renewed leases that are planned for the relevant future time period. The example illustrates a report prepared prior to May 31, 2009 in order to plan expenses for the May 31, 2009 to Dec. 31, 2010 planning period.

Planning data 210 includes data that user 135 may use to make planning decisions. In the example, planning data 210 describes a recovery amount calculated from the forecasted charges and the planned expenses, for example, by subtracting the planned expenses from the forecasted charges. Additionally, planning data 210 may track the effect of applying potential changes to lease data 164. Potential changes refer to proposed modifications requested by user 135 for evaluation and planning purposes. User 135 may evaluate the effect of a potential change in order to determine whether to implement the potential change. As an example, a potential change may comprise a potential rate change. In some embodiments, the potential rate change may refer to an increase or decrease to the current rate according to a percentage, a specified dollar amount, or other value. For example, a three percent increase to a lease having a rate of two dollars per square foot may be used to evaluate the effect of charging two dollars and six cents per square foot. In some embodiments, planning data 210 may comprise an indicator indicating whether the potential rate change results in an under-recovery. For example, an indicator may be generated based on comparing the recovery amount to a target recovery level.

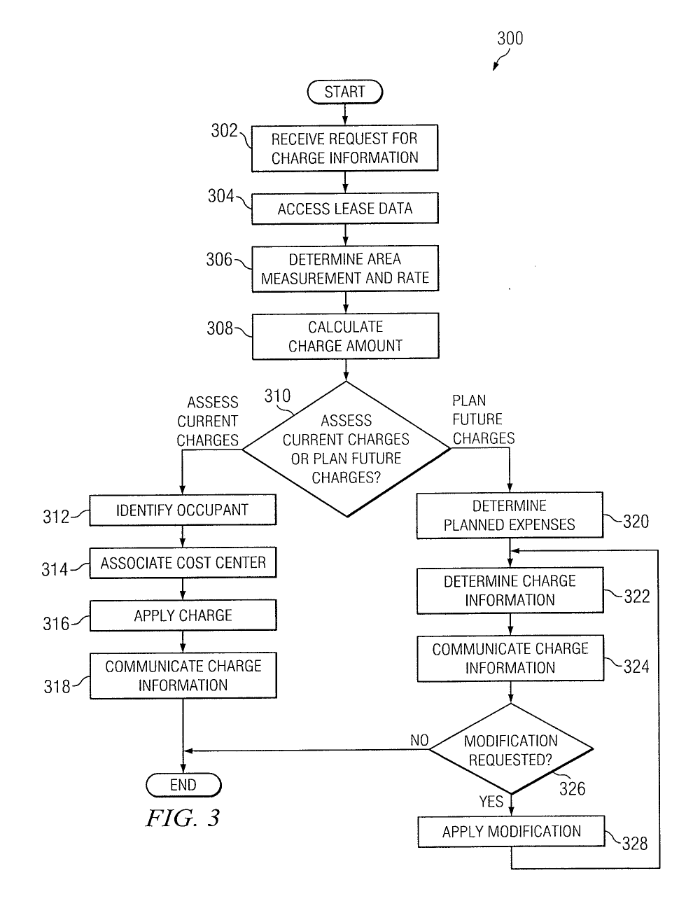

FIG. 3 illustrates a flowchart for rate evaluation and planning. Beginning at step 302, the method receives a request for charge information associated with a selected leased space. Charge information refers to any information suitable for assessing current charges or planning future charges for the selected leased space. In some embodiments, leased space may refer to a building or a portion of a building, such as one or more floors or one or more rooms.

The method accesses lease data for a plurality of leased spaces at step 304. Lease data includes an area measurement and a rate associated with each leased space. The area measurement describes the size of the leased space, for example, the number of square feet, square meters, rooms, floors, or any other measurement. The rate describes charges per unit of area measurement, such as dollars per square foot.

At step 306, the method determines the area measurement and the rate associated with the selected leased space. In some embodiments, the rate associated with one leased space may differ from the rate associated with another leased space. Thus, the rate associated with one building may differ from the rate associated with another building. Similarly, the rate associated with one floor of a building may differ from the rate associated with another floor located in the same building. Factors affecting the rate may include the start date of the lease, the term of the lease, the geographical region, the site of the property, the type of property, the line of business occupying the leased space, and so on. Accordingly, the method may determine the particular rate associated with the selected leased space.

In order to determine the area measurement and the rate, the method considers whether the request received in step 302 requested charge information for assessing current charges or for planning future charges. When assessing current charges, the area measurement may refer to a current area measurement, such as an amount of space currently occupied. Similarly, the rate may refer to a current rate, that is, a rate that is currently effective.

When planning future charges, the area measurement may refer to a planned area measurement and the rate may refer to a potential rate proposed by the user for evaluation purposes. In some embodiments, the current area measurement may be used as a baseline to determine the planned area measurement. The baseline may be modified based on anticipated changes, for example, if the occupant is scheduled to occupy an additional floor or evacuate a current floor during the time period being planned. In some embodiments, the current rate may be used as a baseline to determine the potential rate. The baseline may be modified based on anticipated changes. For example, if the expenses associated with the leased space are anticipated to increase, the potential rate may be increased to a value selected to recover the increased expenses.

Continuing to step 308, the method calculates a charge amount based on the area measurement and the rate. As an example, the charge amount may be equal to the area measurement multiplied by the rate per unit of area. In some embodiments, the calculation may take other data into consideration. For example, the calculation may include normalization credits reflecting fair market rent.

At step 310, the method determines whether to proceed with assessing current charges or with planning future charges. In some embodiments, the determination may be made according to an indicator in the request indicating whether to assess current charges or to plan future charges. As another example, the indicator may indicate a requested time period. If the time period corresponds to a current charging period, the method may proceed with assessing current charges mode. If the time period corresponds to a future charging period, the method may proceed with planning future charges mode. To assess current charges, the method continues to step 312. To plan future charges, the method resumes at step 320.

Continuing to step 312, in order to facilitate assessing current charges, the method identifies an occupant of the selected leased space. The occupant may be identified from the lease data corresponding to the leased space, by mapping the leased space to an occupant according to a table or database, by querying the user, or other suitable method.

At step 314, the method associates the occupant with a cost center responsible for the charges. As an example, the method may map the occupant to the cost center according to a hierarchical mapping, such as an organizational chart. The organizational chart may arrange the hierarchy based on any suitable criteria, such as geography and/or line of business. As an example, a hierarchy based on geography may map a leased space to a city, a state, a region (e.g., North, South, East, West), a country, and so on. The responsible cost center may be defined at any level of the hierarchy. For example, a state level cost center may be responsible for leased spaces located within a particular state. Alternatively, a regional level cost center may be responsible for leased spaces located in multiple states.

At step 316, the method applies the charge amount calculated in step 308. Applying the charge amount may refer to associating the charge amount with the appropriate cost center. In some embodiments, applying the charge amount may further include deducting the charge amount from a financial account of the cost center.

The method communicates the charge information at step 318. As an example, the charge information may include the charge amount and/or the cost center. The assessing current charges method then ends.

Returning to step 312, to plan future charges, the method continues to step 322 to determine planned expenses. Examples of expenses include property management fees, telecommunications, utilities, rent, depreciation, insurance, property tax, maintenance and janitorial services, and other base expenses and/or operating expenses. In some embodiments, current expenses may be used as a baseline to determine planned expenses. The baseline may be modified based on anticipated changes. As an example, utilities expenses may be anticipated to increase based on increases to a contracted utility rate or trend data suggesting the occupant's usage of the utility is increasing.

The method determines the charge information at step 322. In some embodiments, the charge information may include the charge amount, planning data, and/or other charge information. Planning data may indicate whether the potential rate results in an under-recovery or an acceptable recovery based on a comparison between the charge amount and the planned expenses. For example, in some embodiments, the planning data may comprise a recovery amount. The recovery amount may be calculated by subtracting planned expenses from the charge amount. The recovery amount may be compared to a target recovery level, such as a selected target profit level or break-even level.

At step 324, the method communicates charge information to the user. The charge information may include the charge amount, the planning data, and/or other charge information. The user may evaluate the charge information to determine whether to accept the potential rate or to request a modification. For example, if the recovery amount is less than the target recovery level, the user may decide to modify the potential rate. If the recovery amount equals the target recovery level, the user may decide to accept the potential rate without any modification.

The method determines whether the user requested a modification to the potential rate at step 326. If the user requests a modification, the method applies the modification at step 328. Applying the modification may include generating a record of the changed portion of the lease data, the user that requested the change, and the timestamp of the change. During a subsequent audit, the record may be included in an audit report to assist an auditor in reviewing the changes. After applying the modification, the method returns to step 322 to determine the charge information based on the modified rate. The method continues to step 324 to communicate the updated charge information then to step 326 to determine whether further modifications are requested. If no further modifications are requested, the method ends.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described in detail, it should be understood that various changes, substitutions, and alterations can be made hereto without departing from the scope of the invention as defined by the appended claims.

What is claimed is:

1. A method, comprising:
receiving a request for charge information associated with a selected leased space of a plurality of leased spaces;
accessing lease data for the plurality of leased spaces, the lease data comprising an area measurement and a rate associated with each leased space;
determining the area measurement and the rate associated with the selected leased space;
calculating, by a processor, a charge amount based on the area measurement and the rate associated with the selected leased space;
determining the charge information associated with the charge amount; and
communicating the charge information.

2. The method of claim 1, further comprising:
identifying an occupant of the selected leased space;
associating the occupant with a cost center responsible for paying the charge amount; and
applying the charge amount to the cost center.

3. The method of claim 1, wherein:
the charge information comprises a recovery amount; and
the determining the area measurement and the rate associated with the selected leased space comprises determining a planned area measurement and a potential rate; and
further comprising:
determining planned expenses associated with the selected leased space; and
calculating the recovery amount based on the charge amount and the planned expenses.

4. The method of claim 1, wherein:
the charge information comprises planning data; and
the determining the area measurement and the rate associated with the selected leased space comprises determining a planned area measurement and a potential rate; and
further comprising:
determining planned expenses associated with the selected leased space;
comparing the charge amount and the planned expenses; and
determining whether the planned expenses are greater than the charge amount.

5. The method of claim 4, further comprising:
receiving a request to apply the potential rate;
applying the potential rate;
generating updated charge information; and
communicating the updated charge information.

6. The method of claim 1, further comprising:
determining whether a change to the lease data occurred; and
generating an audit report identifying a changed portion of the lease data if a change occurred.

7. A non-transitory computer readable storage medium comprising logic, the logic, when executed by a processor, operable to:
receive a request for charge information associated with a selected leased space of a plurality of leased spaces;
access lease data for the plurality of leased spaces, the lease data comprising an area measurement and a rate associated with each leased space;
determine the area measurement and the rate associated with the selected leased space;
calculate a charge amount based on the area measurement and the rate associated with the selected leased space;
determine the charge information associated with the charge amount; and
communicate the charge information.

8. The computer readable storage medium of claim 7, further operable to:
identify an occupant of the selected leased space;
associate the occupant with a cost center responsible for paying the charge amount; and
apply the charge amount to the cost center.

9. The computer readable storage medium of claim 7, wherein:
the charge information comprises a recovery amount; and
the area measurement corresponds to a planned area measurement and the rate corresponds to a potential rate; and
the computer readable storage medium further operable to:
determine planned expenses associated with the selected leased space; and
calculate the recovery amount based on the charge amount and the planned expenses.

10. The computer readable storage medium of claim 7, wherein:
the charge information comprises planning data; and
the area measurement corresponds to a planned area measurement and the rate corresponds to a potential rate; and
the computer readable storage medium further operable to:
determine planned expenses associated with the selected leased space;
compare the charge amount and the planned expenses; and
determine whether the planned expenses are greater than the charge amount.

11. The computer readable storage medium of claim 10, further operable to:
receive a request to apply the potential rate;
apply the potential rate;
generate updated charge information; and
communicate the updated charge information.

12. The computer readable storage medium of claim 7, further operable to:
determine whether a change to the lease data occurred; and
generate an audit report identifying a changed portion of the lease data if a change occurred.

13. A system, comprising:
an interface operable to:
receive a request for charge information associated with a selected leased space of a plurality of leased spaces; and
one or more processors operable to:
access lease data for the plurality of leased spaces, the lease data comprising an area measurement and a rate associated with each leased space;
determine the area measurement and the rate associated with the selected leased space;
calculate a charge amount based on the area measurement and the rate associated with the selected leased space; and
determine the charge information associated with the charge amount; and
the interface further operable to communicate the charge information.

14. The system of claim 13, the one or more processors further operable to:
identify an occupant of the selected leased space;
associate the occupant with a cost center responsible for paying the charge amount; and
apply the charge amount to the cost center.

15. The system of claim 13, wherein:
the charge information comprises a recovery amount; and
the area measurement corresponds to a planned area measurement and the rate corresponds to a potential rate; and
the one or more processors further operable to:
determine planned expenses associated with the selected leased space; and
calculate the recovery amount based on the charge amount and the planned expenses.

16. The system of claim 13, wherein:
the charge information comprises planning data; and
the area measurement corresponds to a planned area measurement and the rate corresponds to a potential rate; and
the one or more processors further operable to:
determine planned expenses associated with the selected leased space;
compare the charge amount and the planned expenses; and
determine whether the planned expenses are greater than the charge amount.

17. The system of claim 16, further comprising:
the interface further operable to:
receive a request to apply the potential rate;
the one or more processors further operable to:
apply the potential rate; and
generate updated charge information; and
the interface further operable to:
communicate the updated charge information.

18. The system of claim 13, the one or more processors further operable to:
determine whether a change to the lease data occurred; and
generate an audit report identifying a changed portion of the lease data if a change occurred.
